(19) United States
(12) Patent Application Publication
(10) Pub. No.: US 2022/0344864 A1
(43) Pub. Date: Oct. 27, 2022

(54) ELECTRICAL CONNECTOR HAVING AN INSULATIVE COVER RECEIVING AN INSULATIVE HOUSING AND A SEALING MEMBER DISPOSED BETWEEN THE INSULATIVE COVER AND THE INSULATIVE HOUSING

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: MIN-HAN LIN, New Taipei (TW); DING-CHERNG CHEN, New Taipei (TW)

(21) Appl. No.: 17/727,159

(22) Filed: Apr. 22, 2022

(30) Foreign Application Priority Data
Apr. 26, 2021 (CN) 202120871409.6

(51) Int. Cl. H01R 13/52; H01R 13/516; H01R 13/415

(52) U.S. Cl. CPC H01R 13/5202; H01R 13/516; H01R 13/415

(57) ABSTRACT

An electrical connector includes an insulative cover having a dividing wall and defining a mating space in front of the dividing wall and a mounting space behind the dividing wall, an insulative housing received in the mounting space of the insulative cover, plural contacts insert-molded with the insulative housing and extending through the dividing wall to expose in the mating space, and a sealing member disposed between the dividing wall and the insulative housing.

### BACKGROUND OF THE INVENTION

### 1. Field of the Invention

The present invention relates to an electrical connector comprising an insulative cover having a dividing wall and defining a front mating space and a rear mounting space, an insulative housing received in the mounting space of the insulative cover, a plurality of contacts insert-molded with the insulative housing and extending through the dividing wall to expose in the mating space, and an internal sealing member for water-proof purpose.

### 2. Description of Related Arts

Taiwan Utility Model No. 456615 discloses an electrical connector comprising a metallic shell, a contact module received by the metallic shell, an insulative cover molded over the metallic shell and the contact module, and an external sealing member at an outer face of the insulative cover.

A water-proof electrical connector of a different design is desired.

### SUMMARY OF THE INVENTION

An electrical connector comprises an insulative cover having a dividing wall and defining a mating space in front of the dividing wall and a mounting space behind the dividing wall, an insulative housing received in the mounting space of the insulative cover, a plurality of contacts insert-molded with the insulative housing and extending through the dividing wall to expose in the mating space, and a sealing member disposed between the dividing wall and the insulative housing.

### BRIEF DESCRIPTION OF THE DRAWING

FIG. 1 is a perspective view of an electrical connector in accordance with the present invention;

FIG. 2 is another perspective view of the electrical connector;

FIG. 3 is an exploded view showing a part of the electrical connector;

FIG. 4 is a view similar to FIG. 3 but showing a sealing member of the electrical connector disposed in place;

FIG. 5 is an exploded view of the electrical connector;

FIG. 6 is another exploded view of the electrical connector; and

FIG. 7 is a cross-sectional view of the electrical connector taken along line A-A in FIG. 1.

### DETAILED DESCRIPTION OF THE PREFERRED EMBODIMENT

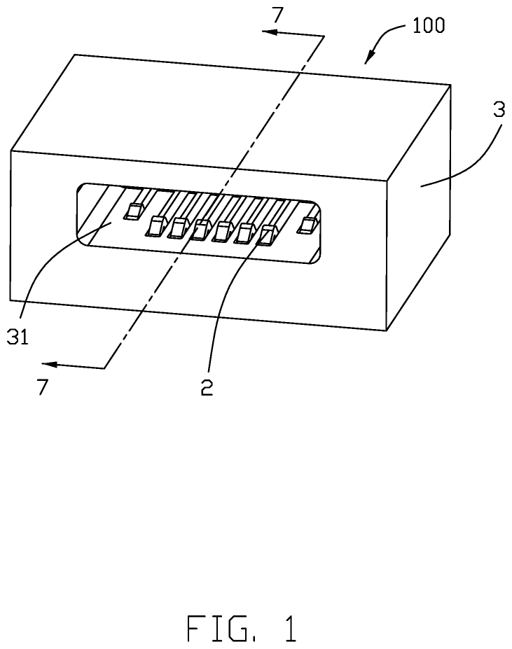

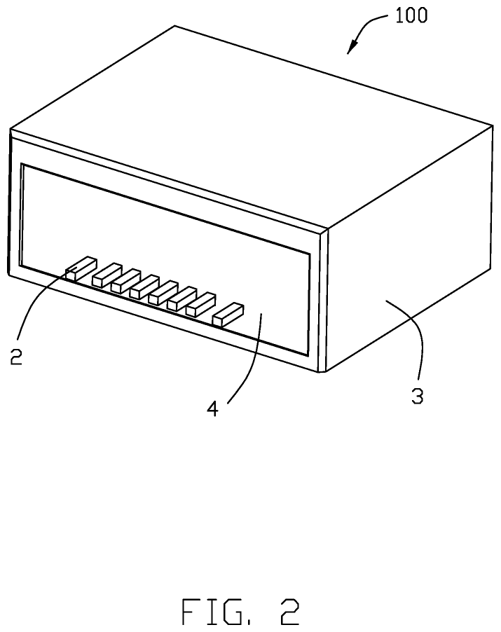

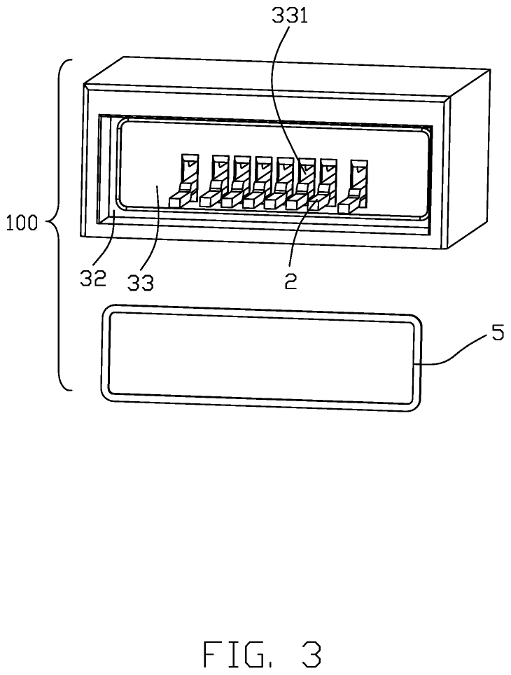

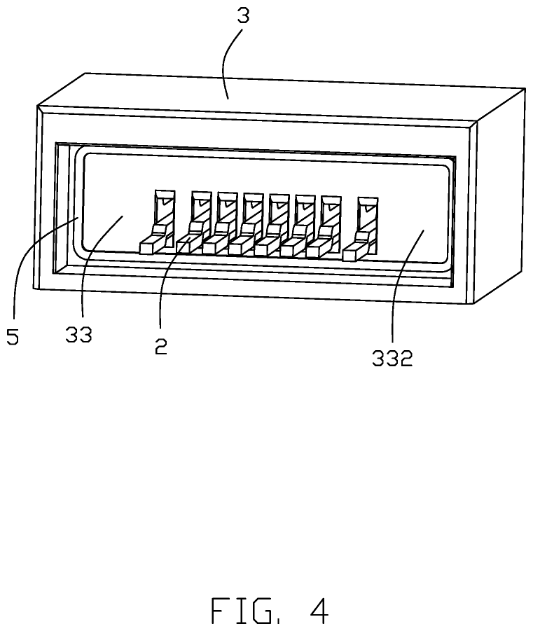

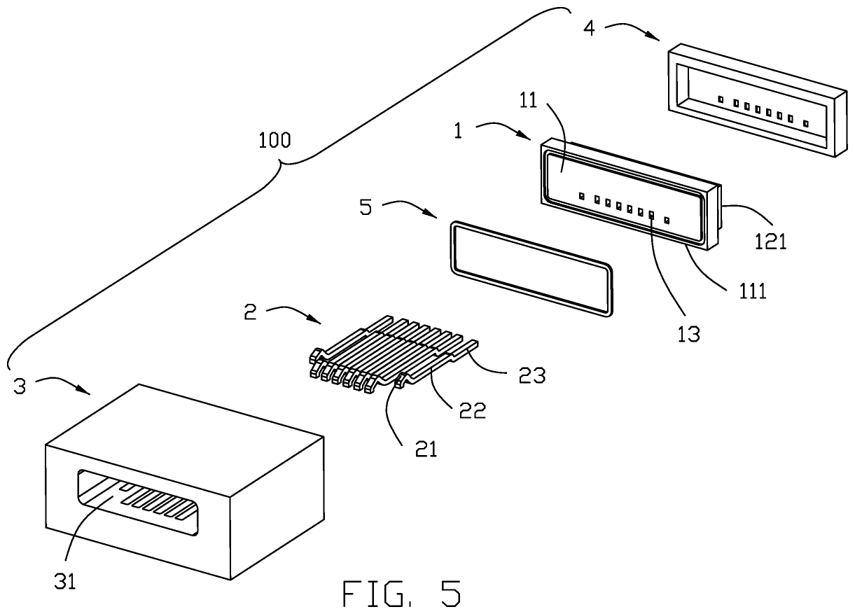

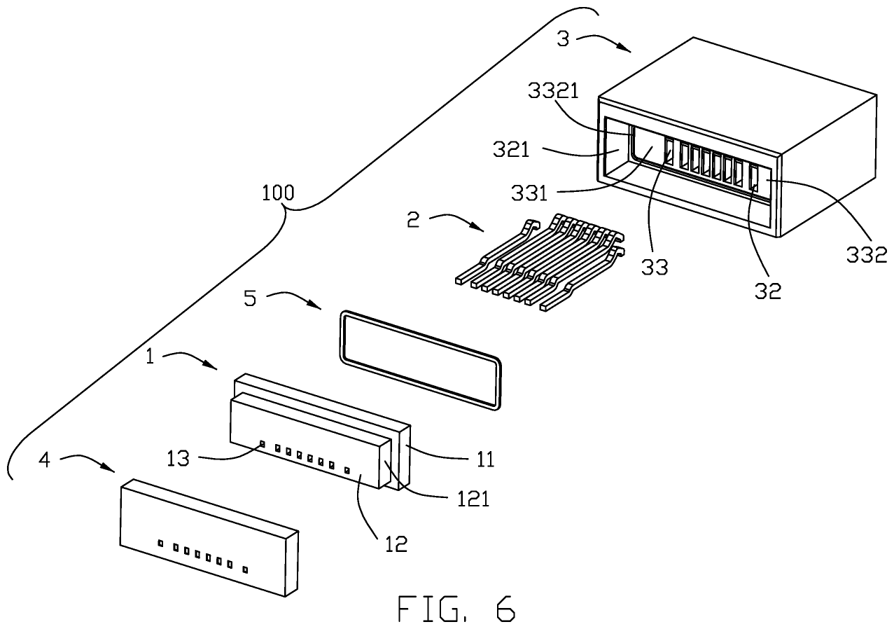

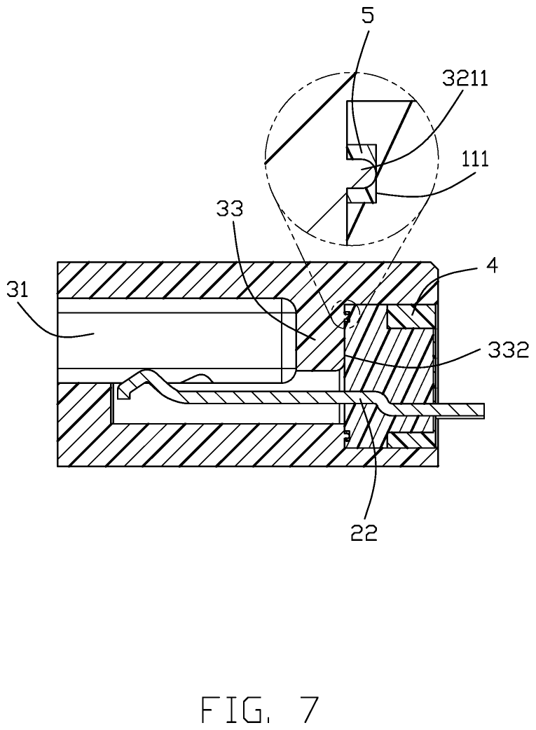

Referring to FIGS. 1 to 7, an electrical connector 100 comprises an insulative cover 3 having a dividing wall 33 and defining a mating space 31 in front of the dividing wall 33 and a mounting space 32 behind the dividing wall 33, an insulative housing 1 received in the mounting space 32 of the insulative cover 3, a plurality of contacts 2 insert-molded with the insulative housing 1 and extending through the dividing wall 33 to expose in the mating space 31, and a sealing member 5 disposed between the dividing wall 33 and the insulative housing 1. The electrical connector 100 may further include a rear sealing member 4 disposed behind the insulative housing 1 in the mounting space 32.

Each of the plurality of contacts 2 has a front contacting portion 21, an intermediate securing portion 22, and a rear tail 23.

The insulative cover 3 has a seamless structure. The dividing wall 33 has a plurality of grooves 331 in communication between the mating space 31 and the mounting space 32. The electrical connector 100 further has a filling space 321 behind the insulative housing 1 where the rear sealing member 4 is disposed.

The insulative housing 1 has a front face 11, a rear face 12, and a plurality of grooves 13 occupied by the contacts 2. The insulative housing 1 is mounted from a rear side into the mounting space 32 of the insulative cover 3 until the front face 11 abuts a rear face 332 of the dividing wall 33. The contacting portion 21 extends through the groove 13 into the mating space 31. One of the front face 11 of the insulative housing 1 and the rear face 332 of the dividing wall 33 is disposed with a rib and the other with a corresponding channel. In the present embodiment, the rear face 332 of the dividing wall 33 has a rib 3321 and the front face 11 of the insulative housing 1 has a matching channel 111. A rear end of the insulative housing 1 has a step 121.

For a structure that an insulative housing is mounted into a rear mounting space of an insulative cover until a front face of the insulative housing abuts a dividing wall of the insulative cover, a potential water or moisture flow path would exist from the grooves 331, along an interface between the dividing wall and the insulative housing and then an interface between the insulative housing and a rear sealing member, to around areas of contacts at a junction between the insulative housing and the rear sealing member. When there is leak, concerned areas of the contacts may be eroded. With provision of the sealing member 5 disposed between the dividing wall 33 and the insulative housing 1, such potential water or moisture flow path is blocked. The sealing member 5 essentially seals an interface between the rear face 332 of the dividing wall 33 and the front face 11 of the insulative housing 1. The sealing member 5 may be an elastomer O-ring that is received in the channel 111 and pressed by the rib 3321. The sealing member 5 may also be a glue block cured in place.

What is claimed is:

1. An electrical connector comprising:
an insulative cover having a dividing wall and defining a mating space in front of the dividing wall and a mounting space behind the dividing wall;
an insulative housing received in the mounting space of the insulative cover;
a plurality of contacts insert-molded with the insulative housing and extending through the dividing wall to expose in the mating space; and
a sealing member disposed between the dividing wall and the insulative housing.

2. The electrical connector as claimed in claim 1, wherein the sealing member seals an interface between a rear face of the dividing wall and a front face of the insulative housing.

3. The electrical connector as claimed in claim 1, wherein the sealing member comprises an O-ring.

4. The electrical connector as claimed in claim 1, wherein the sealing member comprises a cured glue.

5. The electrical connector as claimed in claim 1, wherein one of the insulative housing and the dividing wall has a rib and the other has a corresponding channel, and the sealing member fills a space between the rib and the channel.

6. The electrical connector as claimed in claim 1, further comprising a rear sealing member disposed behind the insulative housing.
